(19) United States
(12) Patent Application Publication
(10) Pub. No.: US 2025/0392904 A1
(43) Pub. Date: Dec. 25, 2025

(54) Call Transfer Management Between Linked Devices

(71) Applicants: AT&T Intellectual Property I, L.P., Atlanta, GA (US); AT&T Mobility II LLC, Atlanta, GA (US)

(72) Inventors: Rashmi Palamadai, Naperville, IL (US); Robert Holden, Allen, TX (US); Peter Wong, Redmond, WA (US)

(73) Assignees: AT&T Intellectual Property I, L.P., Atlanta, GA (US); AT&T Mobility II LLC, Atlanta, GA (US)

(21) Appl. No.: 18/750,598

(22) Filed: Jun. 21, 2024

(51) Int. Cl. H04W 8/26

(52) U.S. Cl. CPC H04W 8/26

(57) ABSTRACT

Concepts and technologies disclosed herein are directed to providing a call transfer management service that enables management of calls and call transfers between linked devices to provide optimal connectivity for calls. A system can receive a notification that a first device and a second device are linked devices. In response, the system can determine that the first and second devices are linked devices. While the first and second devices remain within proximity of one another and in response to determining that the devices are linked, the system can modify call data associated with outgoing calls from the second device to assign a telephone number of the first device to the outgoing calls and modify call data associated with incoming calls to the first device to reroute the incoming calls to the second device. The system can also transfer an in-progress call handled by the first device to the second device.

### BACKGROUND

The current technology of pairing between mobile devices and vehicles, such as BLUETOOTH pairing, exhibits several significant limitations and deficiencies. One primary issue is the lag experienced during the connection and disconnection processes between a mobile device and a vehicle. This lag can lead to delays and interruptions, all of which negatively impact the user experience. Moreover, interference is a common problem when using a mobile device within a vehicle. The enclosed metallic structure of a vehicle can cause signal degradation, leading to reduced connectivity and path loss. This problem is exacerbated in urban and congested areas where high levels of radio frequency interference are present. Conversely, in rural areas, where reception is inherently weaker, these connectivity issues become more pronounced due to the lack of robust signal strength.

### SUMMARY

Concepts and technologies disclosed herein are directed to providing a call transfer management service that enables management of calls and call transfers between linked devices to provide optimal connectivity for a call. According to one aspect disclosed herein, a system can include a processor and a memory. The memory can store instructions for a call transfer management service that, when executed by the processor, cause the processor to perform operations. In particular, the system can receive a notification that a first device and a second device are linked devices. In response to the notification, the system can determine that the first device and the second device are linked devices. While the first and second devices remain within proximity of one another and in response to determining that the devices are linked, the system can modify call data associated with outgoing calls from the second device to assign a telephone number of the first device to the outgoing calls and can modify call data associated with incoming calls to the first device to reroute the incoming calls to the second device.

The notification can also include a request to transfer an in-progress call between the first device and a third device to the second device. The system can transfer the in-progress call to the second device such that the in-progress call is between the second device and the third device. In particular, the system can instruct a base station serving the first device during the in-progress call to establish a connection with the second device. The system can also instruct the second device to activate a microphone associated with the second device to capture audio detected by the microphone and to send voice packets corresponding to the audio to the system. Audio quality of the voice packets received from the second device can be analyzed by the system in comparison to audio quality of voice packets received from the first device during the in-progress call. In response to determining that the audio quality of the voice packets received from the second device exceeds the audio quality of the voice packets received from the first device, the system can instruct the base station to sever a connection used to service the first device for the in-progress call in favor of the connection between the base station and the second device. The voice packets from the second device can also be sent to the third device, and voice packets from the third device can be forwarded to the second device via the base station to transfer the in-progress call to the second device.

The system can also receive a notification that the first device and the second device are no longer within proximity of one other. Accordingly, the in-progress call can be transferred back to the first device such that the in-progress call is between the first device and the third device.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts and technologies disclosed herein.

FIG. 2A-2B are block diagrams illustrating further aspects of an illustrative operating environment for various concepts and technologies disclosed herein during an in-progress call transfer.

FIG. 3 is a flow diagram illustrating aspects of a method for registering devices as linked devices via a call transfer management service, according to an illustrative embodiment.

FIGS. 4A-4B are flow diagrams illustrating aspects of a method for managing calls when linked devices are within proximity of each, according to an illustrative embodiment.

FIG. 5 is a block diagram of an example network, according to an illustrative embodiment

FIG. 6 is a block diagram illustrating a computer system configured to provide the functionality in accordance with various embodiments of the concepts and technologies disclosed herein.

FIG. 7 is a block diagram of a mobile device and components thereof, according to an illustrative embodiment.

FIG. 8 is a block diagram illustrating a cloud computing platform capable of implementing aspects of the concepts and technologies disclosed herein.

FIG. 9 is a diagram illustrating a machine learning system capable of implementing aspects of the embodiments disclosed herein, according to an illustrative embodiment.

### DETAILED DESCRIPTION

The concepts and technologies disclosed herein provide a call transfer management service that enables management of calls and call transfers between linked devices to provide optimal connectivity for a call. The call transfer management service can receive user input identifying two or more communication devices, such as a user device and a connected car, to be associated as linked devices for implementing call transfers. The user input can also specify identifier data, such as a telephone number of the user device, to be assigned to both the user device and the connected car while the user device and the connected car are within proximity of one another. For instance, when the user device and connected car are determined to be within proximity of one another, the telephone number of the user device can be assigned to the connected car such that the telephone number of the connected car can appear as that of the user device to parties of in-progress calls handled by the connected car and outgoing calls from the connected car. Moreover, incoming calls to the telephone number of the user device can be routed to the connected car when the user device and connected car are determined to be within proximity of one another. The call transfer management service can generate and store a subscriber record including the user input and can provide the subscriber record to at least one of the user device and/or the connected car.

While the user device is engaged in a call with a destination device via a radio access network (“RAN”), proximity with another device, such as the connected car, may be detected. In particular, a determination can be made that a user using the user device has entered the connected car. In response to the detection of the user device and the connected car being within proximity of one another, a determination can be made whether the user device and connected car are linked devices. For instance, the user device can access the subscriber record provided by the call transfer management service to determine if identifier data associated with the connected car determined to be within proximity of the user device matches a linked device of the user device provided by the subscriber record. If a match is determined, a call transfer management client executed by the user device can send a message to a server computer executing the call transfer management service. The message can include information identifying the user device, the connected car, and the destination device engaged in the call with the user device. In addition, the message can include a request to transfer the in-progress call from the user device to the connected car so that the in-progress call can continue via communication components of the connected car, which may provide stronger connectivity for calls while the user device is within the connected car.

In response to receiving the message from the user device, the call transfer management service can confirm that the connected car is a linked device with the user device, identify a call session corresponding to the in-progress call between the user device and the destination device, and initiate a transfer process to transfer the in-progress call that the user device is engaged in to the connected car. During the transfer process, the call transfer management service can instruct the base station of the RAN servicing the user device to establish a dedicated radio bearer connection with the connected car to allow the connected car to transmit voice packets to and receive voice packets from the base station. The call transfer management service can also instruct the connected car to activate a microphone of the connected car to capture audio detected by the microphone and to send the audio as voice packets to the call transfer management service via the established connection with the base station. For instance, the connected car can capture audio of the user during the in-progress call between the user device and the destination device while the user is in the connected car and send the audio as voice packets to the call transfer management service. Additionally, the call transfer management service can duplicate voice packets received from the destination device during the call session with the user device and forward the duplicated voice packets to the connected car via the base station. Since the connected car is sending and receiving voice packets that mirror the voice packets sent and received by the user device, the connected car and the user device are in parallel call sessions with the destination device. In order to determine which call session to maintain, an audio analysis module of the call transfer management service can analyze audio quality of the voice packets received from both the connected car and the user device during the call sessions to determine when the audio quality of the voice packets received from the connected car exceeds the audio quality of the voice packets received from the user device. When the connected car's audio quality exceeds that of the user device, the call transfer management service can instruct the base station to sever the call session between the user device and the destination device in favor of the call session between the connected car and the destination device, thus transferring the in-progress call to the connected car.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

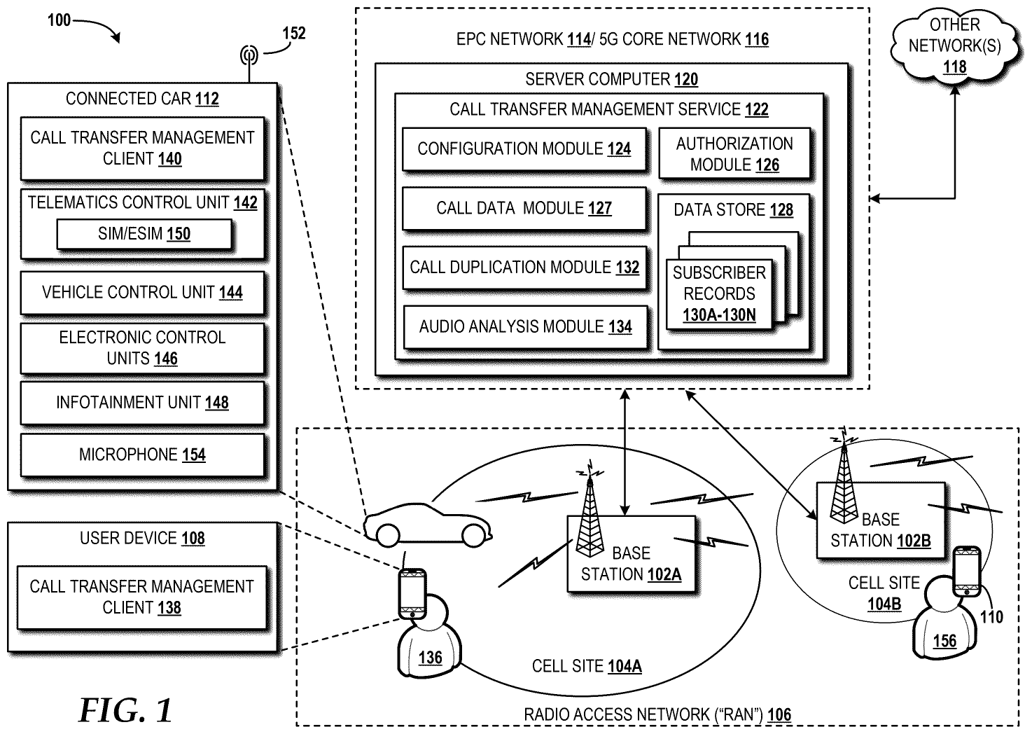

Turning now to FIG. 1, aspects of an operating environment 100 for various embodiments of the concepts and technologies disclosed herein will be described, according to an illustrative embodiment. The operating environment 100 includes a first base station 102A providing a first cell site 104A and a second base station 102B providing a second cell site 104B. The first base station 102A and the second base station 102B form, at least in part, a radio access network (“RAN”) 106. Although only two base stations 102A, 102B are shown in the illustrated example of the RAN 106, more than two base stations may be deployed as part of the RAN 106.

The RAN 106 can be configured in accordance with Third Generation Partnership Project (“3GPP”) technical specifications for E-UTRAN and/or next generation (“5G”) RAN architectures. As such, in some embodiments, the base stations 102A, 102B can be or can include an eNodeB (“eNB”), a gNodeB (“gNB”), or a combined eNB/gNB. Those skilled in the art will appreciate the applicability of the concepts and technologies disclosed herein to other RAN architectures or variations of the aforementioned RAN architectures.

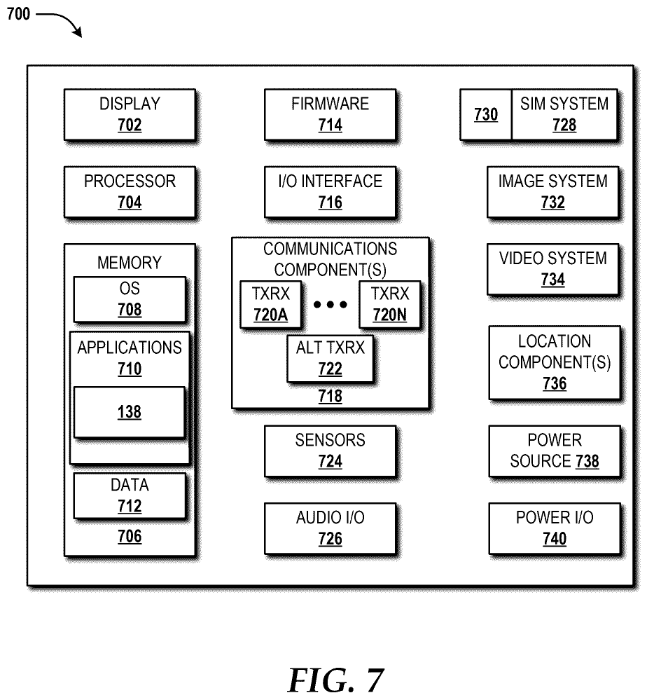

The base stations 102A, 102B can provide a radio/air interface over which user equipment (“UE”), such as a user device 108, a destination device 110, and a connected car 112, can connect to the RAN 106. The user and destination devices 108, 110 each may be a cellular phone (e.g., a feature phone or smartphone), a mobile computing device, a tablet computing device, a wearable device, a portable television, a portable video game console, or any other computing device that includes one or more radio access components that are capable of connecting to and communicating with one or more RANs, such as the RAN 106, via one or more radio access components. The connected car 112 may be any type of vehicle that includes one or more radio access components capable of connecting to and communicating with one or more RANS, such as the RAN 106, via one or more radio access components. In some embodiments, the user and destination devices 108, 110 and the connected car 112 can include an integrated or external radio access component that facilitates wireless communication with one or more RANs, such as the RAN 106. The radio access component may be a mobile device that is in wired or wireless communication with the user and destination devices 108, 110 and the connected car 112 to facilitate a tethered data connection to one or more RANs, such as the RAN 106. Alternatively, the radio access component includes a wireless transceiver configured to send data to and receive data from one or more RANs, such as the RAN 106, and a universal serial bus (“USB”) or another communication interface for connection to the mobile device so as to enable tethering. In any case, the user and destination devices 108, 110 and the connected car 112 can wirelessly communicate with one or more RANs over a radio/air interface in accordance with one or more radio access technologies (“RATs”). The user and destination devices 108, 110 and the connected car 112 may also initiate, receive, and maintain voice calls with one or more other voice-enabled telecommunications devices, such as other mobile devices or landline devices (not shown). The user and destination devices 108, 110 and the connected car 112 may also exchange Short Message Service (“SMS”) messages, Multimedia Message Service (“MMS”) messages, email, and/or other messages with other devices (not shown). Additional details regarding the communication components of the user and destination devices 108, 110 will be described below with reference to FIG. 7.

The base stations 102A, 102B can provide dual connectivity for the user and destination devices 108, 110 and the connected car 112 to access an LTE cell and/or 5G-NR cell. As such, the cell sites 104A, 104B in the illustrated example should be construed as LTE cells, 5G-NR cells, or combination LTE/5G-NR cells. This example, however, should not be construed as being limiting in any way.

The cell sites 104A, 104B are geographical areas served by the base stations 102A, 102B, respectively. A mobile network operator (“MNO”) can install the base stations 102A, 102B to provide network access for the user and destination devices 108, 110 and the connected car 112 (and/or other devices that are not shown) in specific geographic locations. The base stations 102A, 102B can include one or more LTE radio components and/or one or more 5G-NR radio components to generate radio waves to be broadcast by an associated antenna system.

The base stations 102A, 102B are shown as being in communication with core networks, including an evolved packet core (“EPC”) network 114 and a 5G core network 116. The core networks 114, 116 are, in turn, in communication with one or more other networks 118 such as one or more other public land mobile networks (“PLMNs”), one or more packet data networks (“PDNs”) (e.g., the Internet), combinations thereof, and/or the like. The user and destination devices 108, 110 and the connected car 112 can access services (not shown) provided, at least in part, via the other network(s) 118.

The base stations 102A, 102B can connect to the EPC network 114, and more specifically, to a mobility management entity (“MME”) (not shown) and a serving gateway (“SGW”) (also not shown). The EPC network 114 can include one or more MMEs, one or more SGWs (which may be combined with one or more packet gateways (“PGWs”)), and one or more home subscriber servers (“HSS”). Although not shown in the illustrated example, the EPC network 114 can include these network elements and may additionally include other network elements not specifically mentioned herein. In general, the EPC network 114 can be implemented based upon 3GPP technical specifications.

The core network components of the EPC network 114 can be implemented as physical network functions (“PNFs”) having hardware and software components. The core network components of the EPC network 114 can additionally or alternatively be provided, at least in part, by virtual network functions (“VNFs”). For example, the core network components can be realized as VNFs that utilize a unified commercial-of-the-shelf (“COTS”) hardware and flexible resources shared model with the application software for the respective core network components running on one or more virtual machines (“VMs”). Moreover, the core network components can be embodied as VNFs in one or more VNF pools, each of which can include a plurality of VNFs providing a particular core network function.

An MME can be configured in accordance with 3GPP standards specifications and can perform operations to control signaling traffic related to mobility and security for access to an eNB portion of the base stations 102A, 102B. The MME also can be in communication with an HSS. These network elements can communicate via interfaces that are defined as part of 3GPP technical specifications.

An SGW and a PGW can be configured in accordance with 3GPP technical specifications. The SGW can provide a point of interconnect between an eNB portion of the base stations 102A, 102B and the EPC network 114. The SGW can serve the user and destination devices 108, 110 and the connected car 112 by routing incoming and outgoing IP packets between the eNB portion of the base stations 102A, 102B and the EPC network 114. The PGW interconnects the EPC network 114 to the other networks 118. The PGW routes IP packets to and from the other network(s) 118. The PGW also performs operations such as IP address/prefix allocation, policy control, and charging. The SGW and the PGW can be in communication with the MME and with the other network(s) 118. These network elements can communicate via interfaces that are defined as part of 3GPP technical specifications.

An HSS can be configured in accordance with 3GPP technical specifications. The HSS is a database that contains user-related information for users of devices such as the user and destination devices 108, 110 and the connected car 112. The HSS can provide support functions to the MME for mobility management, call and data session setup, user authentication, and access authorization.

The MME and SGW can be connected to the base stations 102A, 102B at the edge of the EPC network 114. The eNB and the gNB portions of the base stations 102A, 102B are logically different components that can communicate with each other via a standardized IP interface (i.e., the X2 interface). If the eNB and gNB are combined into a single hardware node, the X2 interface is an internal interface (or logical interface) between the two components.

The 5G core network 116 can include network functions that provide functionality similar to that of the EPC network 114 described above for LTE but for 5G technologies such as mmWave. For example, current 3GPP technical specifications define a 5G core network architecture as having an access and mobility management function (“AMF”) that provides mobility management functionality similar to that of an MME in the EPC network 114; a session management function (“SMF”) that provides session management functionality similar to that of an MME and some of the S/PGW functions, including IP address allocation, in the EPC network 114; an authentication server function (“AUSF”) that manages subscriber authentication during registration or re-registration with the 5G core network 116; a Unified Data Management (“UDM”) function that manages subscriber data, authentication, authorization, and mobility management functions similar to that of an HSS in the EPC network 114; and user plane function (“UPF”) that combines the user traffic transport functions previously performed by the S/PGW in the EPC network 114, among others. While 3GPP has defined some of these network functions, these network functions may be split into greater granularity to perform specific functions, may be combined, and/or additional functions may be added by the time the MNO deploys a live 5G network. As such, the 5G core network 116 is intended to encompass any and all 5G core network functions that are currently defined in technical specifications currently available and revisions thereof made in the future.

According to embodiments, the evolved packet core 114 and/or the 5G core network 116 includes a server computer 120 hosting a call transfer management service 122 that enables devices to be associated as linked devices and calls to be transferred between the linked devices to provide optimal connectivity for the calls. According to various embodiments of the concepts and technologies disclosed herein, the functionality of the server computer 120 may be provided by one or more server computers, application servers, web servers, data processing resources, gateway devices, routers, other computing systems, and the like. It should be understood that the functionality of the server computer 120 may be provided by a single device, by two or more similar devices, and/or by two or more dissimilar devices. For purposes of describing the concepts and technologies disclosed herein, the server computer 120 is described herein as an application server. It should be understood that this embodiment is illustrative, and should not be construed as being limiting in any way.

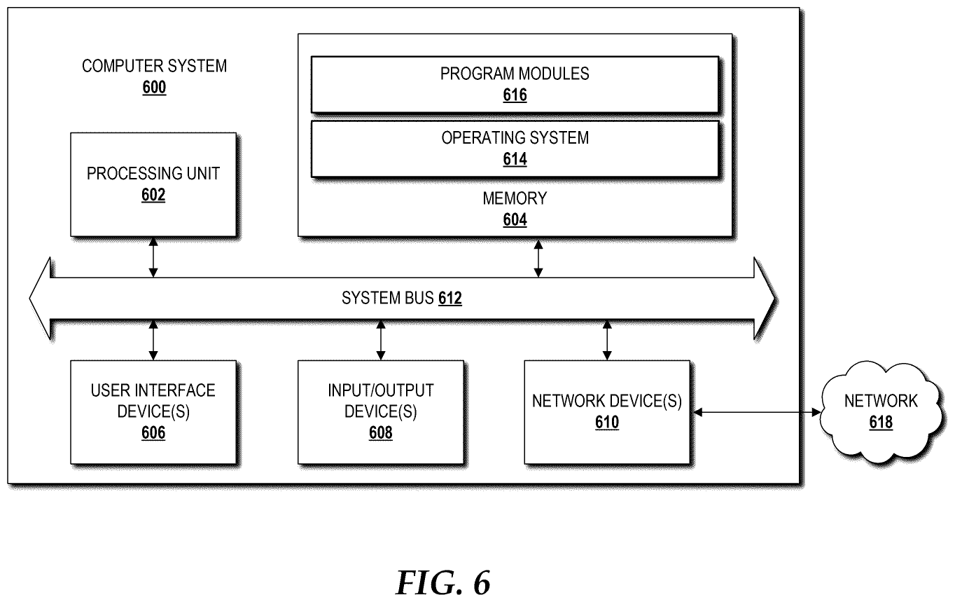

The call transfer management service 122 can be a software module executed by a processor of the server computer 120 or can be hardware modules or combinations of hardware and software that perform the operations described herein. Details regarding the components of the server computer 120 will be described below with reference to FIG. 6. The call transfer management service 122 can include a configuration module 124, an authorization module 126, a call data module 127, a data store 128, a call duplication module 132, and an audio analysis module 134. According to embodiments, the configuration module 124 of the call transfer management service 122 can receive input from a user 136 (referred to herein as “user input”) of a user device, such as the user device 108, requesting that the user device 108 and at least one other device, such as the connected car 112, be associated together as linked devices for managing calls and implementing call transfers when the user device 108 and the connected car 112 are determined to be within proximity of one another. The device to be linked with the user device 108 may also be associated with the user 136 or may be associated with a different user or entity, as discussed further below. The user input can be received from the user device 108 via an application, such as a call transfer management client 138, downloaded to and/or installed on the user device 108. The call transfer management client 138 can be a software module executed by a processor 704 of the user device 108, illustrated and discussed further with regards to FIG. 7, or can be hardware modules or combinations of hardware and software that perform the operations described herein. Alternatively, the user input can be received from the user device 108 via a website, application, and/or other interface hosted by the call transfer management service 122. The user input can be received when the user 136 registers for the call transfer management service 122, when a new UE is purchased/leased/rented, in response to detection of an event and/or proximity to a device, periodically, on request, and/or at any other time the user 136 determines to associate devices as linked devices. According to embodiments, the configuration module 124 can verify that the user 136 and/or the user device 108 are authorized to configure devices as linked devices by employing, for example, an authentication technique including, but not limited to, passwords, credentials, pins, biometric data, sensors, and the like.

According to embodiments, the user input can include identifier data indicative of the devices for which linking is to be initiated. The identifier data can be any information that can be used to identify the devices to be linked such as, for example, telephone numbers associated with the devices, contact information associated with the user(s) of the devices, information associated with one or more owners of the devices, predefined codes associated with linked devices, and the like. Additionally or alternatively, the call transfer management service 122 can utilize information received during communication with a device, such as the user device 108, to identify the user device 108 as well as other devices associated with the user 136 of the user device 108. For instance, the call transfer management service 122 may use the telephone number associated with the user device 108 to request information from the HSS of the EPC network 114 and/or the UDM of the 5G core network 116 regarding the user 136 of the user device 108 and other devices associated with the user 136, such as the connected car 112. According to embodiments, the call transfer management service 122 may provide a list of devices associated with the user 136 to the user device 108 for selection of one of the devices to be linked to the user device 108.

If a request is made to link a device not associated with the user 136 to the user device 108, the request can be provided to the authorization module 126 to verify that the user 136 consents to linking the user device 108 with the requested device. For example, if a request from the user device 108 and/or a car rental company is received to link a rental car with the user device 108, the request can be provided to the authorization module 126 to confirm that the user 136 authorizes linking the user device 108 with the rental car. Moreover, when devices to be linked are not associated with the same user, the user input can include timing data specifying a time period for which the devices are to be linked to one another. Continuing with the example above, if one of the devices to be linked is a rental car, the user 136 can request that the rental car be linked to a user device 108 of the user 136 for a specific duration of time such as, for example, the duration of time that the user 136 is renting the rental car. After the specific duration of time lapses, the link between the rental car and the user device 108 is discontinued.

According to embodiments, the user input can also specify identifier data to be assigned and shared by the linked devices when the devices are within proximity of one another. For instance, when the user device 108 and the connected car 112 are determined to be within proximity of one another, the telephone number of the user device 108 can be assigned to both the user device 108 and the connected car 112 such that the telephone number of the connected car 112 can appear as that of the user device 108 to parties of in-progress calls handled by the connected car 112 and outgoing calls from the connected car 112. Moreover, incoming calls to the telephone number of the user device 108 can be routed to the connected car 112 when the user device 108 and connected car 112 are determined to be within proximity of one another. The configuration module 124 can store the user input configuring the devices as linked devices in the data store 128 as subscriber records 130A-130N. Once generated, the call transfer management service 122 can provide one or more of the subscriber records 130A-130N to the devices configured as linked devices.

Once devices are registered with the call transfer management service 122 as linked devices, the call transfer management service 122 can monitor for a message from one of the linked devices indicating that proximity to the other linked device has been detected. For instance, the call transfer management service 122 may receive a message from the user device 108 identifying the user device 108 and the connected car 112 and indicating that the user device 108 is within proximity of the connected car 112. The user device 108 can detect the presence of another device using a variety of wireless communications such as, for example, BLUETOOTH, near field communication (“NFC”), WI-FI direct, radio frequency identification (“RFID”), vehicle-to-everything (“V2X”) communications, and the like. For instance, the connected car 112 can emit BLUETOOTH signals that the user device 108 can detect and infer proximity to the connected car 112 based on the strength of the BLUETOOTH signals. Alternatively or additionally, proximity can also be determined in response to the user 136 providing input to another device, such as the connected car 112, either via a user interface provided by the call transfer management client 140 of the connected car 112 and/or the call transfer management client 138 of the user device 108 indicating that the user 136 and/or user device 108 is/are in proximity of the connected car 112, and more specifically, within the connected car 112; in response to one or more sensors of the connected car 112 capturing biometric data associated with the user 108 or another user; and/or using any other method of determining proximity of devices. According to embodiments, the call transfer management client 138 of the user device 108 can instruct the user device 108 to monitor for proximity with another device, such as the connected car 112, at a predetermined frequency that can be adjusted by the user 136 of the user device 108.

Regardless of how proximity is determined, in response to receiving the message from the user device 108 indicating that proximity with the connected car 112 has been detected, the call transfer management service 122 can confirm that the user device 108 and the connected car 112 are linked devices. Prior to sending the message to the call transfer management service 122, the user device 108 can determine whether the connected car 112 is a linked device with the user device 108. According to embodiments, the user device 108 can access a subscriber record, such as the subscriber record 130A, provided by the call transfer management service 122 to determine if identifier data associated with the connected car 112 matches a linked device of the user device 108 provided by the subscriber record 130A. If a match is determined, the call transfer management client 137 executed by the user device 108 can send the message to the call transfer management service 122 regarding detection of proximity with a linked device. The message can include information identifying the user device 108, the connected car 112, and any device engaged in a call with the user device 108 at the time of proximity detection with the connected car 112. In response to receiving the message from the user device 108, the call transfer management service 122 can search the subscriber records 130A-130N for one or more records associated with the user device 108 and/or the connected car 112 identified by the message received from the user device 108. If a subscriber record (e.g., the subscriber record 130A) associated with the user device 108 and/or the connected car 112 is found, the call transfer management service 122 can verify, based on the subscriber record 130A, that the user device 108 and the connected car 112 are associated together as linked devices. Once confirmed, the call transfer management service 122 can set a flag or status indicator in the data store 128 indicating that the user device 108 and the connected car 112 are within proximity of each other. The call transfer management service 122 can continuously monitor for messages from the user device 108 and/or the connected car 112 suggesting a change in status of the proximity of the devices and can change the flag or status associated with the devices indicator accordingly.

In response to verifying that the user device 108 and the connected car 112 are linked devices, the call transfer management service 122 can access the subscriber record 130A to determine identifier data to be assigned and shared by the user device 108 and the connected car 112 while the devices remain within proximity of one another. For instance, the subscriber record 130A can set forth the telephone number of the user device 108 as the identifier data to be assigned to both the user device 108 and the connected car 112 while the devices are within proximity of one another such that the telephone number of the connected car 112 appears as that of the user device 108 to parties of in-progress calls transferred to the connected car 112 and outgoing calls from the connected car 112. According to embodiments, while the user device 108 and the connected car 112 are within proximity of one another, the call data module 127 of the call transfer management service 122 can receive call data about an in-progress call to be transferred from the user device 108 to the connected car 112, described further below, and about outgoing calls from the connected car 112 and can modify the call data to replace the telephone number of the connected car 112 with the telephone number of the user device 108. Thus, call notifications presented to the devices, such as the destination device 110, of the in-progress call and/or the outgoing calls include the telephone number of the user device 108 instead of the connected car 112 even though the calls are handled by the connected car 112. The call data can be provided to the call data module 127 by one or more network elements, such as an MME or AMF of the EPC network 114 or 5G core network 116, respectively, to the call data module 127, and the modified call data generated by the call data module 127 can be provided to the same network elements for further processing of the calls.

Moreover, in response to verifying that the user device 108 and the connected car 112 are linked devices, incoming calls to the telephone number of the user device 108 can be rerouted to the connected car 112 while the user device 108 and connected car 112 are within proximity of one another. According to embodiments, the call data module 127 of the call transfer management service 122 can receive call data about incoming calls directed to the user device 108 and can instruct one or more network elements, such as an MME or AMF of the EPC network 114 or 5G core network 116, respectively, to redirect the incoming call to the connected car 112 but to continue to use the telephone number of the user device 108 for call notifications to the calling party.

Turning back to the message received from the user device 108, if the user device 108 is involved in a call when proximity with the connected car 112 is detected, the message from the user device 108 may also include a request to transfer the in-progress call to the connected car 112. For instance, if the user device 108 is engaged in a call with the destination device 110, the message can request to transfer the in-progress call so that the in-progress call can continue via communication components of the connected car 112, which may provide stronger connectivity for the call with the destination device 110 while the user device 108 is within proximity of the connected car 112. In such instances, in addition to identifying the user device 108 and the connected car 112, the message received from the user device 108 can also identify the other device, such as the destination device 110, involved in the in-progress call with the user device 108. Alternatively, the request to transfer the in-progress call may be received in response to the user 136 selecting an option presented by the call transfer management client 138 of the user device 108 and/or selecting an option presented by the call transfer management client 140 of the Regardless of how the request is received, in response to receiving a request to transfer the in-progress call from the user device 108 to the connected car 112, the call transfer management service 122 can use the message received from the user device 108 to identify a call session corresponding to the in-progress call. For instance, the call transfer management service 122 can use the identifier data from the message corresponding to the user device 108 and the destination device 110 to query one or more network elements, such as the S/PGW of the EPC network 114 or the UPF of the 5G core network 116, for information about the call session corresponding to the in-progress call between the user device 108 and the destination device 110. The information about the call session can include, but is not limited to, information identifying a base station, such as the base station 102A, of the RAN 106 servicing the user device 108 during the call session, security parameters relevant to the call session, a current state of the call session, and/or any other information about the call session that the call transfer management service 122 can use during a transfer process to transfer the in-progress call that the user device 108 is engaged in to the connected car 112.

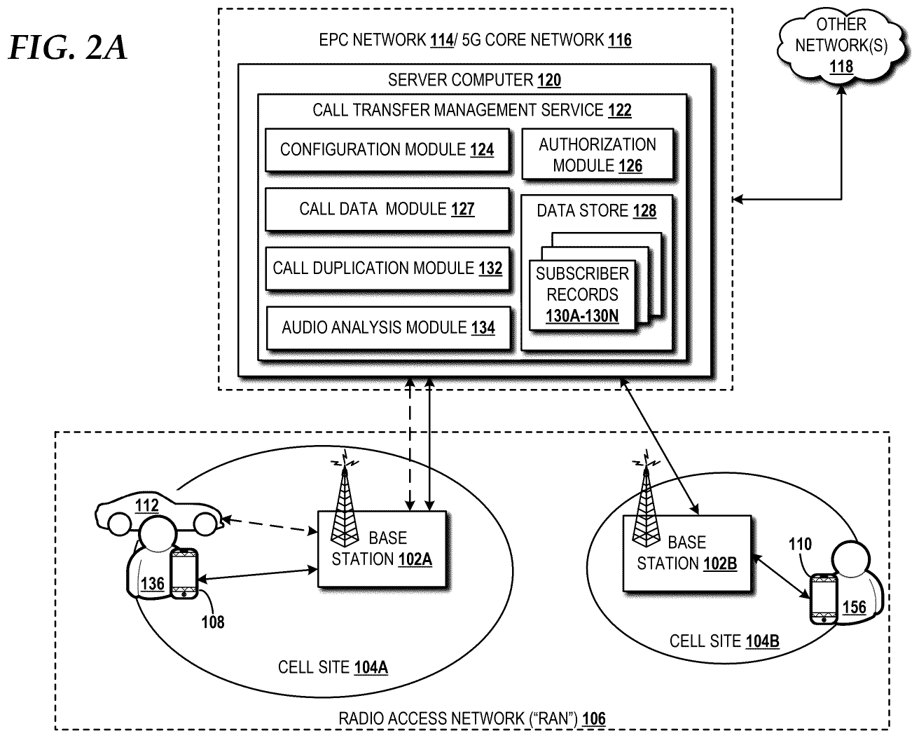

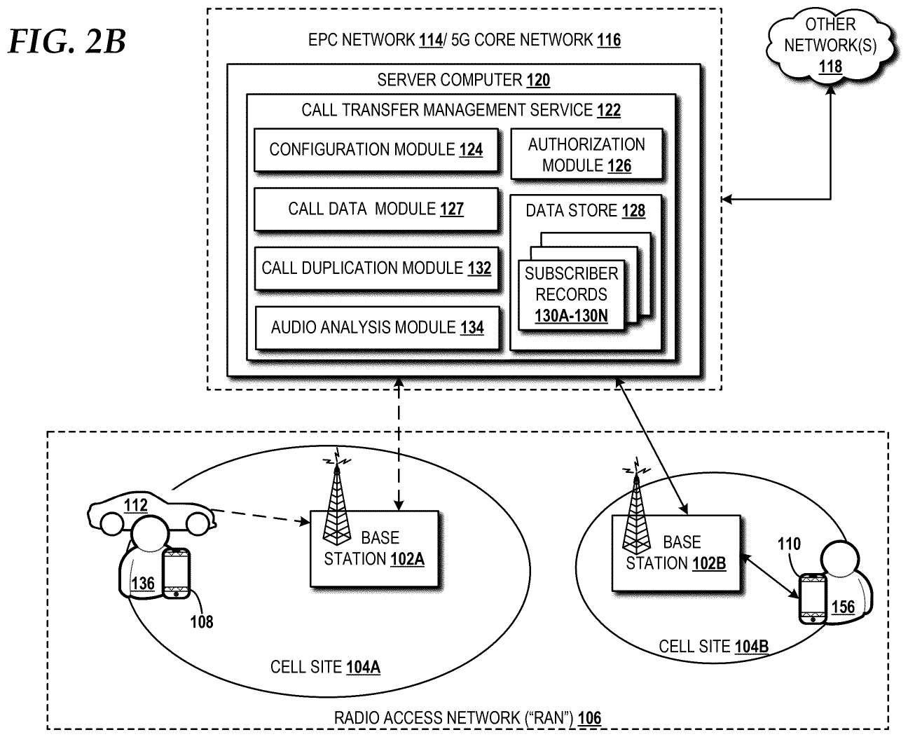

Turning now to FIG. 2A with continued reference to FIG. 1, using the information about the call session corresponding to the in-progress call determined from the one or more network components, the call transfer management service 122 can initiate a transfer process to transfer the in-progress call between the user device 108 and the destination device 110 to the connected car 112 and the destination device 110. According to embodiments, the call transfer management service 122 can instruct the base station 102A of the RAN 106 servicing the user device 108 to establish a connection, such as a dedicated radio bearer connection, with the connected car 112 to allow the connected car 112 to transmit voice packets to and receive voice packets from the base station 102A. Since the connected car 112 and the user device 108 are within proximity of each other, the base station 102A can be used by the call transfer management service 122 to establish a connection with the connected car 112.

The call transfer management service 122 can continue the transfer process by instructing the connected car 112 to activate a microphone, such as the microphone 154 illustrated in FIG. 1, to capture audio detected by the microphone 154 and to send the audio as voice packets to the call transfer management service 122 via the established connection with the base station 102A. The call transfer management service 122 can send the instructions to the connected car 112 via the base station 102A and the established connection or via a specialized server or gateway of one of the core networks 114, 116 that provides services for the connected car 112 such as vehicle-to-infrastructure (“V2I”) communication, over-the-air updates, telematics services, or the like. In response to the instructions from the call transfer management service 122, the connected car 112 can activate the microphone 154, capture audio of the user 136 during the in-progress call between the user device 108 and the destination device 110 while the user 136 is within proximity of the connected car 112 (i.e., while the user 136 using the user device 108 is positioned within the connected car 112), and send the captured audio as voice packets to the call transfer management service 122. Accordingly, the voice packets corresponding to the audio captured by the microphone 154 sent by the connected car 112 mirror voice packets sent by the user device 108 during the in-progress call while the user 136 and the user device 108 are within proximity of the connected car 112. The voice packets corresponding to the captured audio can be sent by the connected car 112 to the call transfer management service 122 via the established connection with the base station 102A.

In addition to receiving the voice packets from the connected car 112 corresponding to audio of the user 136 captured during the in-progress call between the user device 108 and the destination device 110, the call duplication module 132 of the call transfer management service 122 can duplicate voice packets received from the destination device 110 during the in-progress call between the user device 108 and the destination device 110. The duplicated voice packets can be forwarded to the connected car 112 via the base station 102A, while the original voice packets from the destination device 110 are forwarded to the user device 108 engaged in the in-progress call with the destination device 110. Since the connected car 112 sends voice packets captured by the microphone 154 that mirror voice packets sent by the user device 108 during the in-progress call and receives voice packets duplicative of voice packets received from the destination device 110 during the in-progress call, the connected car 112 is in a call session with the destination device 110 manufactured by the call transfer management service 122 that parallels the call session of the user device 108 and the destination device 110.

Turning back to the voice packets received from the connected car 112 corresponding to audio captured by the microphone 154, as the voice packets are received, the audio analysis module 134 of the call transfer management service 122 can analyze audio quality of the voice packets in comparison to audio quality of the voice packets received from the user device 108 engaged in the in-progress call to determine when the audio quality of the voice packets received from the connected car 112 exceeds that of the voice packets received from the user device 108. As discussed further below, an antenna system 152 of the connected car 112 can provide optimal connectivity with the RAN 106 when the user device 108 is in proximity of the connected car 112 (e.g., within the connected car 112). According to embodiments, the audio analysis module 134 can use one or more analysis techniques including, but not limited to, quality of service monitoring, subjective and objective quality assessment methods (e.g., mean opinion score testing and R-Factor calculation), specialized protocols (e.g., Perceptual Evaluation of Speech Quality and Perceptual Objective Listening Quality Analysis), Real-Time Transport Protocol (“RTP”) and RTP Control Protocol monitoring, and/or active and passive monitoring tools to monitor the performance of the voice packets from the connected car 112 versus those from the user device 108. When the audio analysis module 134 determines that the audio quality of the voice packets from the connected car 112 exceeds that of the user device 108, the call transfer management service 122 can instruct the base station 102A to sever the connection with the user device 108 in favor of the connection with the connected car 112. The call transfer management service 122 can also forward the voice packets from the destination device 110 to the connected car 112 such that the in-progress call with the destination device 110 is transferred to the connected car 112, as illustrated in FIG. 2B. As discussed above, to a user 156 of the destination device 110, the transferred in-progress call will still appear to be associated with the user device 108 since the call data module 127 of the call transfer management service 122 can receive call data about the in-progress call and can modify the call data to replace the telephone number of the connected car 112 with the telephone number of the user device 108 once the call is transferred to the connected car 112.

Returning to FIG. 1, an example device, represented by the connected car 112, linked to the user device 108 is illustrated in accordance with an illustrative embodiment. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided. Although the linked device is shown and described as being a connected car 112, it should be understood that the linked device could be other types of vehicles, equipment, and/or devices.

The connected car 112 includes a call transfer management client 140, a telematics control unit (“TCU”) 142, a vehicle control unit (“VCU”) 144, electronic control units (“ECUs”) 146, an infotainment unit 148, and a microphone 154. The components of the connected car 112 can be connected to and communicate via a data bus (not shown). The data bus of the connected car 112 may provide pathways for multiple network protocol communications such as, but not limited to controller area network (“CAN”), local interconnect network (“LIN”), FlexRay, media-oriented system transport (“MOST”), and the like. In some cases, the TCU 142, the VCU 144, the ECUs 146, the infotainment unit 148, and data bus may collectively provide a hardware platform of the connected car 112.

The TCU 142 may include hardware components along with associated logic, circuitry, interfaces, memory, and/or code that enable the connected car 112 to communicate with devices, such as the user device 108, and with external networks, such as the RAN 106, WI-FI networks, and satellite systems. In addition, the TCU 142 can communicate wirelessly with sensors and interfaces onboard the connected car 112 to collect data about the performance, status, and environment of the connected car 112. In an embodiment, the TCU 142 may send and/or receive information via communications in accordance with wireless communication standards or protocols, such as a cellular standard (e.g., protocols such as LTE, 5G, or earlier generations), Institute of Electrical and Electronics Engineers (IEEE) 802.11 standard, BLUETOOTH standard, ZIGBEE standard, and/or other wireless standards; NFC; infrared-based communications; optical-based communications; and/or other appropriate communication standards and/or protocols. In some cases, the TCU 142 may be configured to communicate with devices using a proprietary wireless communication protocol and interface. Alternatively or in addition, the TCU 142 may include suitable logic, circuitry, interfaces, memory, and/or code that enable wired communications. In this regard, the connected car 112 may be configured to interface with a wired network, such as via an Ethernet interface, a power-line modem, a Digital Subscriber Line (DSL) modem, a Public Switched Telephone Network (PSTN) modem, a cable modem, and/or other appropriate components for wired communication. A wired link may be implemented with a USB cable, power-line cable, coaxial cable, fiber-optic cable, or other cable or wires that support corresponding wired network technologies. For instance, the TCU 142 may be, or may include, a USB port that can receive a USB cable. When the USB cable is used to connect, for example, the user device 108 to the connected car 112, the USB cable may be used to transmit data to and/or receive data from the user device 108. In addition, the TCU 142 can communicate with sensors and interfaces onboard the connected car 112 through wired connections using communication protocols such as CAN, LIN, FlexRay, and the like to collect data about the performance, status, and environment of the connected car 112.

In some embodiments, the TCU 142 may communicate directly with the user device 108 (e.g., directly with a communication unit of the user device 108 in a non-networked manner), such as via BLUETOOTH communication and/or NFC communication. For instance, the TCU 142 may be, or may include, an NFC device (e.g., NFC tag) that may transmit data to and/or receive data from the user device 108 when the user device 108 is placed in proximity of the NFC device. The TCU 142 may also include components that facilitate reception from terrestrial radio networks, digital satellite radio networks, internet-based radio service networks, combinations thereof, and the like. For instance, the TCU 142 can include a GPS receiver to determine a location of the connected car 112, which can be used for navigation, tracking, and location-based services.

The connected car 112 may be in communication with other components, such as the server computer 120 for accessing the call transfer management service 122, via the RAN 106. The TCU 142 of the connected car 112 may include a communication module that sends and/or receives information over the RAN 106, such as to and/or from the call transfer management service 122, the user device 108, and/or the destination device 110, via one or more of the base stations 102A, 102B of the RAN 106. According to embodiments, the TCU 142 includes a subscriber identity module (“SIM”) or embedded subscriber identity module (“eSIM”) 150 to authenticate and identify the connected car 112 to the RAN 106. The TCU 142 may also be integrated with the antenna system 152 of the connected car 112 to optimize signal reception and transmission during communication via the RAN 106. The antenna system 152 may include multiple antennas strategically positioned on the connected car 112, such as on the roof, rear window, or other areas of the connected car 112, to maximize vehicle coverage and minimize signal degradation due to obstacles or interference. The TCU 142 may also utilize antenna technologies such as Multiple Input Multiple Output (“MIMO”) and beamforming to further enhance signal reception and transmission. The positioning of the antenna system 152 and/or technologies utilized by the antenna system 152 of the connected car 112 can cause the connected car 112 to provide superior connectivity for communications associated with the user device 108 in comparison to the connectivity provided by the user device 108 when in proximity of the connected car 112, such as being positioned within the connected car 112. Thus, according to embodiments, an in-progress call handled by the user device 108 can be transferred to the connected car 112, as discussed above, to take advantage of the connectivity afforded by the connected car 112.

The TCU 142 may also control various communication functions of the connected car 112, including activating and deactivating one or more microphones, such as the microphone 154, of the connected car 112 based on instructions received from the call transfer management client 140 executing on the connected car 112. As discussed above, during a transfer process to transfer an in-progress call handled by the user device 108 to the connected car 112, the call transfer management service 122 can instruct the connected car 112 to activate a microphone, such as the microphone 154, of the connected car 112 to capture audio detected by the microphone 154 and to send the audio as voice packets to the call transfer management service 122 via the established connection with the base station 102A. According to embodiments, the call transfer management client 140 of the connected car 112 can receive the instructions from the call transfer management service 122 and, in turn, can instruct the TCU 142 to activate the microphone 154 and send voice packets corresponding to audio captured by the microphone 154 to the call transfer management service 122 via the RAN 106. The call transfer management client 140 can be a software module executed, for example, by one or more computing systems operating as part of the connected car 112. According to embodiments, the call transfer management client 140 can be executed by the VCU 144, the TCU 142, the infotainment unit 148, or one or more other computing component of the connected car 112. Alternatively, the call transfer management client 140 can be hardware modules or combinations of hardware and software that perform the operations described herein. Although the TCU 142 is described as controlling the activation of the microphone 154 of the connected car 112, it should be appreciated that one or more other components of the connected car 112, such as the infotainment unit 148, can also control and/or work with the TCU 142 to control microphones of the connected car 112.

The infotainment unit 148 of the connected car 112 includes components such as a dashboard display, a media center, a center console display, and driver accessible buttons (e.g., temperature controls, door lock controls). The infotainment unit 148 may also include a data store to store media (e.g., movies, music, television programs, podcasts, etc.); system firmware; navigation data; diagnostic information; settings information gathered by the infotainment unit 148 including radio settings, climate control settings, navigation settings, vehicle settings, phone and connectivity settings, display and user interface settings, maintenance and diagnostic settings, and/or safety and assistance settings; and/or data collected by data collection systems (e.g., cameras mounted externally on the connected car 112, weather data collection, etc.

The infotainment unit 148 may also function as a user interface that provides options to a user of the connected car 112 and communicates the user's selected options to one or more components of the connected car 112 such as, but not limited to, the TCU 142, the ECU 146, and/or the VCU 144. In some cases, the infotainment unit 148 may present, via a center console display, selection options associated with transferring an in-progress call being handled by the user device 108 to the connected car 112 and communicate the selected options to the TCU 142 for further communication to the call transfer management service 122. In an embodiment, a display of the user device 108 may be utilized in place of or in addition to the infotainment unit 148, at least with regard to presenting selection options associated with transferring an in-progress call to the connected car 112.

The VCU 144 of the connected car 112 manages and coordinates various systems and subsystems within the connected car 112. According to embodiments, the VCU 144 processes sensor data, executes control algorithms, and coordinates operation of components of the connected car 112. The VCU 144 is in communication with components of the connected car 112 including the ECUs 146, the TCU 142, and the infotainment unit 148. According to embodiments, the VCU 144 can act as a controller for components of the connected car 112, such as the ECUs 146, and can instruct the components to adjust a behavior, location, and/or orientation based on commands received by the VCU 144.

The ECUs 146 of the connected car 112 may be discrete computing devices, each including a processor (e.g., a microcontroller) to process data and execute programmable instructions (e.g., assembly level instructions, functional sequential instructions, and/or object-oriented instructions). Each of the ECUs 146 may include on-board memory (e.g., static random-access memory (“SRAM”), electrically erasable programmable read-only memory (“EEPROM”), and/or flash memory to store data received and/or generated by the ECUs 146. The ECUs 146 may include input and/or output (“I/O”) ports such as supply voltage inputs, digital and/or analog inputs, relay drivers, H-bridge drivers, injector drivers, and/or logic outputs. These I/O ports may be used by the ECUs 146 to receive data (e.g., instructions, sensor data) and transmit signals to components (e.g., actuators, switches) to affect the components' operations. The received data and/or the transmitted signals may be communicated from the ECUs 146 via the data bus or through a directly wired connection between the ECUs 146 and the components. In some aspects, systems (e.g., cabin, engine, cooling, suspension, etc.) of the connected car 112 may operate within confines of operating parameters configured into the systems' corresponding ECUs 146. By way of non-limiting examples, the ECUs 146 may control cabin characteristics, engine performance, transmission, suspension brakes, tire inflation, and/or other aspects of the connected car 112. Each of the ECUs 146 may control an individual aspect of the connected car 112.

FIG. 1 illustrates one server computer 120, one RAN 106, one connected car 112, one user device 108, and one destination device 110. It should be understood, however, that various implementations of the operating environment 100 can include one or more than one server computer 120; one or more than one RAN 106; one or more than one connected car 112, one or more than one user device 108, and one or more than one destination device 110. As such, the illustrated embodiment should be understood as being illustrative, and should not be construed as being limiting in any way.

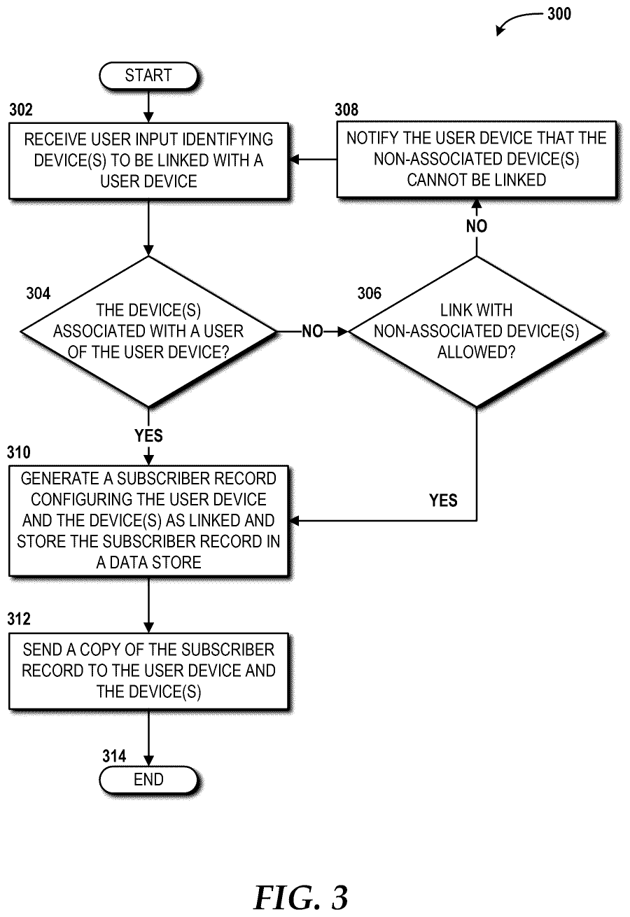

Turning now to FIG. 3, a flow diagram illustrating aspects of a method 300 for registering devices as linked devices via the call transfer management service 122 will be described, according to an illustrative embodiment of the concepts and technologies disclosed herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the methods disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 300 will be described with reference to FIG. 1. The method 300 begins and proceeds to operation 302, where the call transfer management service 122 executed by the server computer 120 can receive user input from a device, such as the user device 108, identifying one or more other devices to be linked with the user device 108 via the call transfer management service 122. The identifier data can be any information that can be used to identify the devices to be linked together such as, for example, telephone numbers associated with the devices, contact information associated with the user(s) of the devices, information associated with one or more owners of the devices, predefined codes associated with linked devices, and the like. Additionally or alternatively, the call transfer management service 122 can utilize information received during communication with the user device 108 to identify the user device 108 as well as other devices associated with the user 136 and provide the user device 108 with a list of associated devices from which to select a device to be linked with the user device 108.

From operation 302, the method 300 proceeds to operation 304, where the call transfer management service 122 can determine whether the devices identified by the user input to be linked together are associated with the user 136. For instance, the call transfer service 122 can determine whether the devices, such as the user device 108 and the connected car 112, are both owned by the user 136, predominantly operated by the user 136, assigned to the user 136, and/or maintained by the user 136. The call transfer management service 122 may use the telephone number associated with the user device 108 to request information from the HSS of the EPC network 114 and/or the UDM of the 5G core network 116 regarding the user 136 and other devices associated with the user 136. Additionally or alternatively, the cell transfer management service 122 may receive information from external sources, such as other telecommunications service providers, car rental services, device manufacturers, government agencies, and the like, about the device, such as the connected car 112, requested to be linked to the user device 108.

In response to determining that the devices are not both associated with the user 136, the method 300 can proceed from operation 304 to operation 306, where the authorization module 126 of the call transfer management service 122 can determine whether the user 136 authorizes a non-associated device to be linked with the user device 108. If a determination is made that the user 136 does not allow the user device 108 to be linked with non-associated devices, the method 300 can proceed from operation 306 to operation 308, where the call transfer management service 122 can provide notification to the user device 108 that the devices cannot be linked. From operation 308, the method 300 can proceed back to operation 302. Returning to operation 306, if a determination is made that the user 136 does allow the user device 108 to be linked with non-associated devices, the method 300 can proceed to operation 310, where the configuration module 124 of the call transfer management service 122 can generate a subscriber record, such as the subscriber record 130A, configuring the user device 108 and the connected car 112 as linked devices and store the subscriber record 130A in the data store 128.

Similarly, returning to operation 304, if a determination is made that the user device 108 and the connected car 112 are both associated with the user 136, the method 300 can proceed to operation 310, where the configuration module 124 of the call transfer management service 122 can generate a subscriber record, such as the subscriber record 130A, configuring the user device 108 and the connected car 112 as linked devices and store the subscriber record 130A in the data store 128. According to embodiments, the subscriber record 130A can include the identifier data provided by the user input identifying the user device 108 and the connected car 112 and an indication that the user device 108 and the connected car 112 are linked devices. The subscriber record 130A can also include identifier data provided by the user input to be assigned and shared by the linked devices when the devices are within proximity of one another. For instance, when the user device 108 and the connected car 112 are determined to be within proximity of one another, the telephone number of the user device 108 can be assigned to both the user device 108 and the connected car 112 such that the telephone number of the connected car 112 can appear as that of the user device 108 to parties of in-progress calls handled by the connected car 112 and outgoing calls from the connected car 112. Moreover, incoming calls to the telephone number of the user device 108 can be routed to the connected car 112 when the user device 108 and connected car 112 are determined to be within proximity of one another. From operation 310, the method 300 can proceed to operation 312, where the call transfer management service 122 can send copies of the subscriber record 130A to the user device 108 and the connected car 112. From operation 312, the method 300 can proceed to operation 314, where the method 300 ends.

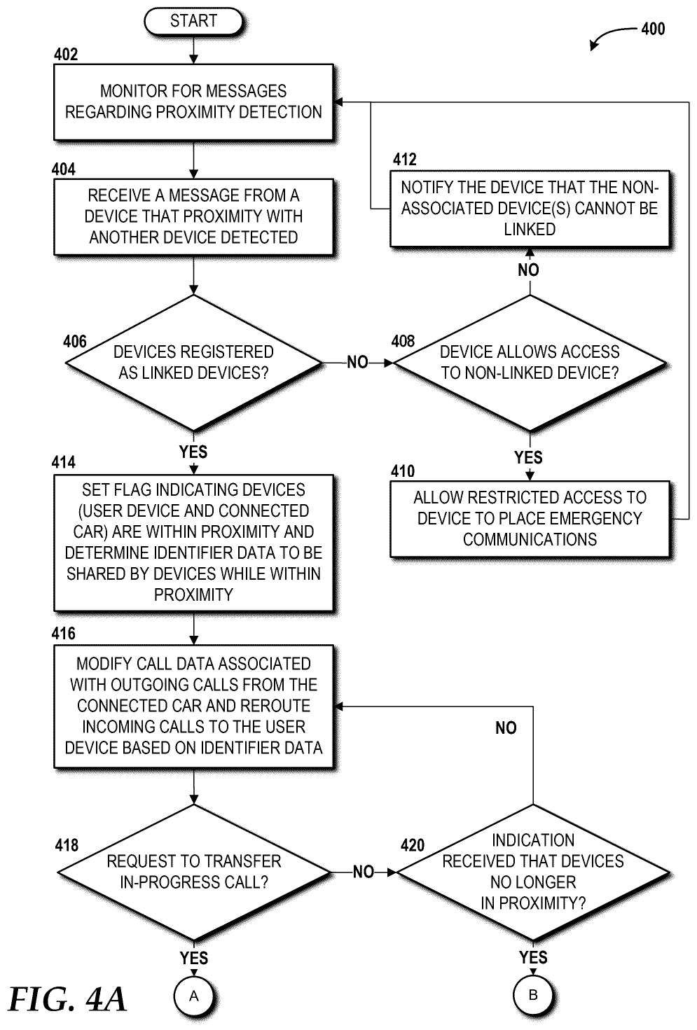

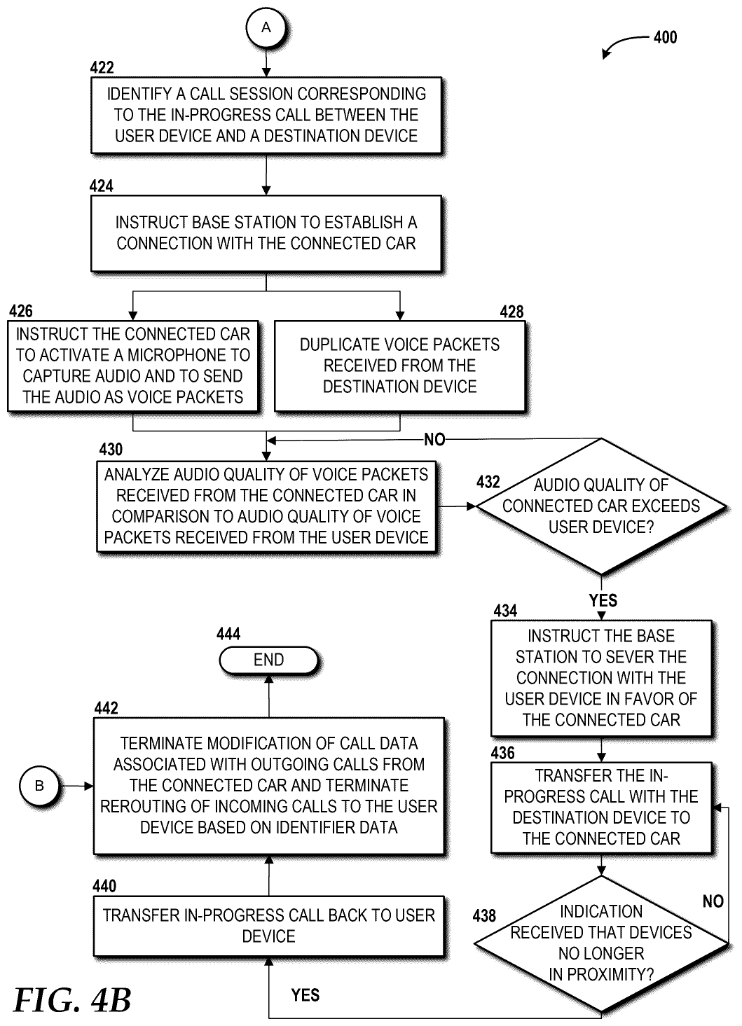

Turning now to FIGS. 4A-4B, a flow diagram illustrating aspects of a method 400 for managing calls when linked devices are within proximity of each other will be described, according to an illustrative embodiment of the concepts and technologies disclosed herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

The method 400 will be described with reference to FIGS. 1 and 2A-2B. The method 400 begins and proceeds to operation 402, where the call transfer management service 122 can monitor for a message from a device regarding proximity detection associated with another device. Although operation 402 is at the beginning of the method 400, it should be appreciated that the call transfer management service 122 can continuously monitor for messages regarding proximity detection throughout the method 400. From operation 402, the method 400 proceeds to operation 404, where the call transfer management service 122 receives a message from a device that proximity with another device has been detected. For instance, the call transfer management service 122 may receive a message from the user device 108 identifying the user device 108 and the connected car 112, indicating that the user device 108 and the connected car 112 are linked devices, and indicating that the user device 108 is within proximity of the connected car 112. Alternatively, the call transfer management service 122 may receive a message from the connected car 112 that a device other than the user device 108 has been detected within proximity of the connected car 112. For instance, proximity with the other device may be determined by the connected car 112 in response to a user of the other device providing input to a user interface provided by the call transfer management client 140 of the From operation 404, the method 400 proceeds to operation 406, where the call transfer management service 122 confirms whether the devices identified in the message received are linked devices. For instance, regarding the message received identifying the user device 108 and the connected car 112, the call transfer management service 122 can search the subscriber records 130A-130N for one or more records associated with the user device 108 and/or the connected car 112 indicating that the user device 108 and the connected car 112 have been registered with the call transfer management service 122 as linked devices. Considering the message received identifying the connected car 112 and the other device, the call transfer management service 122 can search the subscriber records 130A-130N for one or more records associated with the connected car 112 and/or the other device indicating that the devices have been registered with the call transfer management service 122 as linked devices

If, at operation 406, the call transfer management service 122 determines that the devices identified in the message are not registered as linked devices based, for example, on a failure to find a subscriber record indicating that the devices are linked devices (e.g., the specific duration of time that the user device 108 and the connected car 112 are associated as linked devices has lapsed or the connected car 112 and the other device have not been registered as linked devices), the method 400 can proceed to operation 408 where the call transfer management service 122 can determine whether the connected car 112 allows non-linked devices access to the communications components of the connected car 112 such as, for example, in emergency situations. If, at operation 408, the call transfer management service 122 determines that the connected car 112 allows such access with non-linked devices, the method 400 can proceed to operation 410, where the non-linked device is allowed restricted access to the communications components of the connected car 112 to place emergency communications, such as 911 calls. According to embodiments, whether or not the connected car 112 allows non-linked devices access to communications components of the connected car 112 can be stored in one or more of the subscriber records 130A-130N. If, at operation 408, the call transfer management service 122 determines that the connected car 112 does not allow non-linked devices access to the communications components of the connected car 112, the method 400 can proceed to operation 412, where the call transfer management service 122 can notify the user device 108 or the other device of the failure to confirm that the user device 108 and the connected car 112 or the other device and the connected car 112 are linked devices. From operation 410 or 412, the method 400 can proceed back to operation 402, where the call transfer management service 122 can continue to monitor for messages from devices regarding proximity detection.

On the other hand if, at operation 406, the call transfer management service 122 confirms that the user device 108 and the connected car 112 are linked devices based on, for example, finding a subscriber record, such as the subscriber record 130A, indicating that the devices have been registered as linked devices with the call transfer management service 122, the method 400 can proceed to operation 414, where the call data module 127 of the call transfer management service 122 can set a flag or status indicator in the data store 128 indicating that the user device 108 and the connected car 112 are within proximity of each other and determine identifier data, such as the telephone number of the user device 108, from the subscriber record 130A to be shared by the user device 108 and the connected car 112 while the devices remain within proximity of one another. From operation 414, the method 400 can proceed to operation 416, where the call data module 127 can use the identifier data from the subscriber record 130A to modify call data associated with outgoing calls from the connected car 112 to replace the telephone number of the connected car 112 with the telephone number of the user device 108 while the user device 108 and the connected car 112 are within proximity of one another. For instance, if the user 136 places a call using the communications components of the connected car 112 while the user device 108 is proximate to the connected car 112, the notification provided to the called party, such as the destination device 110, regarding the call would include the telephone number of the user device 108 instead of the telephone number of the connected car 112. The call data module 127 can also use the identifier data to reroute incoming calls directed to the user device 108 to the connected car 112 while the user device 108 and connected car 112 are within proximity of one another since the connected car 112 may provide stronger connectivity for calls while the devices are within proximity of one another.

From operation 416, the method 400 proceeds to operation 418, where the call transfer management service 122 can determine whether the message from the user device 108 also includes a request to transfer an in-progress call being handled by the user device 108 to the connected car 112 when the user device 108 is determined to be in proximity of the connected car 112. For instance, if the user device 108 is engaged in a call with the destination device 110 when proximity with the connected car 112 is detected, the message can request to transfer the in-progress call so that the in-progress call can continue via communication components of the connected car 112, which may provide stronger connectivity for the call with the destination device 110 while the user device 108 is within proximity of the connected car 112. In response to determining that the message does not include such a request, the method 400 can proceed to operation 420, where the call transfer management service 122 can determine whether a message has been received indicating that the user device 108 and the connected car 112 are no longer in proximity with one another. If not, then the method 400 can proceed back to operation 416, where the call data module 127 can continue to use the identifier data from the subscriber record 130A to modify call data associated with outgoing calls from the connected car 112 and reroute incoming call directed to the user device 108 to the connected car 112. If, at operation 420, a determination is made that an indication has been received indicating that the user device 108 and the connected car 112 are no longer in proximity with one another, the method 400 can proceed to operation 442, where the call data module 127 can terminate use of the identifier data from the subscriber record 130A to modify call data associated with outgoing calls from the connected car 112 to replace the telephone number of the connected car 112 with the telephone number of the user device 108 and can terminate routing incoming calls directed to the user device 108 to the connected car 112. Moreover, the call transfer management service 122 can remove/update the flag or status indicator in the data store 128 indicating that the user device 108 and the connected car 112 are within proximity of each other to indicate that proximity is no longer detected.

Returning to operation 418, in response to determining that the message includes a request to transfer an in-progress call being handled by the user device 108 to the connected car 112, the method 400 can proceed from operation 418 to operation 422, where the call transfer management service 122 can identify a call session corresponding to the in-progress call based on identifier data corresponding to the user device 108 and/or the destination device 110 from the message. From operation 422, the method 400 proceeds to operation 424, where the call transfer management service 122 initiates a transfer process and instructs the base station 102A of the RAN 106 servicing the user device 108 to establish a connection, such as a dedicated radio bearer connection, with the connected car 112 to allow the connected car 112 to transmit voice packets to and receive voice packets from the base station 102A. From operation 424, the method 400 can proceed to operations 426 and 428. According to embodiments, operations 426 and 428 can occur approximately concurrent with each other. At operation 426, the call transfer management service 122 can continue the transfer process by instructing the connected car 112 to activate the microphone 154 of the connected car 112 to capture audio detected by the microphone 154 and to send the audio as voice packets to the call transfer management service 122 via the established connection with the base station 102A. At operation 428, the call duplication module 132 of the call transfer management service 122 can, optionally, duplicate voice packets received from the destination device 110 during the in-progress call between the user device 108 and the destination device 110 and can forward the duplicated voice packets to the connected car 112 via the base station 102A, while the original voice packets from the destination device 110 are forwarded to the user device 108 engaged in the in-progress call with the destination device 110.

From operations 426 and 428, the method 400 proceeds to operation 430, where the audio analysis module 134 of the call transfer management service 122 can analyze audio quality of voice packets received from the connected car 112 corresponding to audio captured by the microphone 154 in comparison to audio quality of the voice packets received from the user device 108 engaged in the in-progress call. From operation 430, the method 400 proceeds to operation 432, where the call transfer management service 122 determines if the audio quality of the voice packets received from the connected car 112 exceeds that of the voice packets received from the user device 108. If, at operation 432, a determination is made that the audio quality of the voice packets received from the connected car 112 has not exceeded that of the voice packets received from the user device 108, the method 400 can proceed back to operation 430, where the audio analysis module 134 can continue to analyze the audio qualities. If, on the other hand, at operation 432 the audio quality of the voice packets received from the connected car 112 is determined to have exceeded that of the voice packets received from the user device 108, the method 400 can proceed to operation 434, where the call transfer management service 122 can instruct the base station 102A to sever the connection with the user device 108 in favor of the connection with the connected car 112 for the in-progress call with the destination device 110. According to embodiments, the call transfer management service 122 can utilize a generative artificial intelligence model, such as such as generative adversarial networks, variational autoencoders, autoregressive models, transformer models, and/or flow-based models, trained to recognize typical speech patterns to determine a time during the in-progress call to sever the connection with the user device 108 in order to avoid detection of the transfer from the user device 108 to the connected car 112 by the users 108 and 156 of the in-progress call. From operation 434, the method 400 can proceed to operation 436, where the call transfer management service 122 can send the voice packets from the connected car 112 to the destination device 110 and can forward the voice packets from the destination device 110 originally destined for the user device 108 to the connected car 112 such that the in-progress call with the destination device 110 is transferred to the connected car 112.

From operation 436, the method 400 proceeds to operation 438, where the call transfer management service 122 can determine whether an indication has been received from the user device 108 and/or the connected car 112 that the devices are no longer within proximity of one another. If a determination is made that no such indication has been received, the method 400 can proceed back to operation 436, where the in-progress call continues to be handled by the connected car 112. If, on the other hand, a determination is made at operation 438 that an indication has been received that the user device 108 and the connected car 112 are no longer within proximity of each other, the method 400 can proceed to operation 440, where the in-progress call can be transferred back to the user device 108 using similar operations as described above regarding transferring the in-progress call to the connected car 112. From operation 440, the method 400 can proceed to operation 442, where the call data module 127 can terminate use of the identifier data from the subscriber record 130A to modify call data associated with outgoing calls from the connected car 112 to replace the telephone number of the connected car 112 with the telephone number of the user device 108 and can terminate routing incoming calls directed to the user device 108 to the connected car 112. Moreover, the call transfer management service 122 can remove/update the flag or status indicator in the data store 128 indicating that the user device 108 and the connected car 112 are within proximity of each other to indicate that proximity is no longer detected. It should be understood that operations 440 and 442 can occur approximately concurrently to one another. From operation 442, the method 400 can proceed to operation 444, where the method 400 ends.

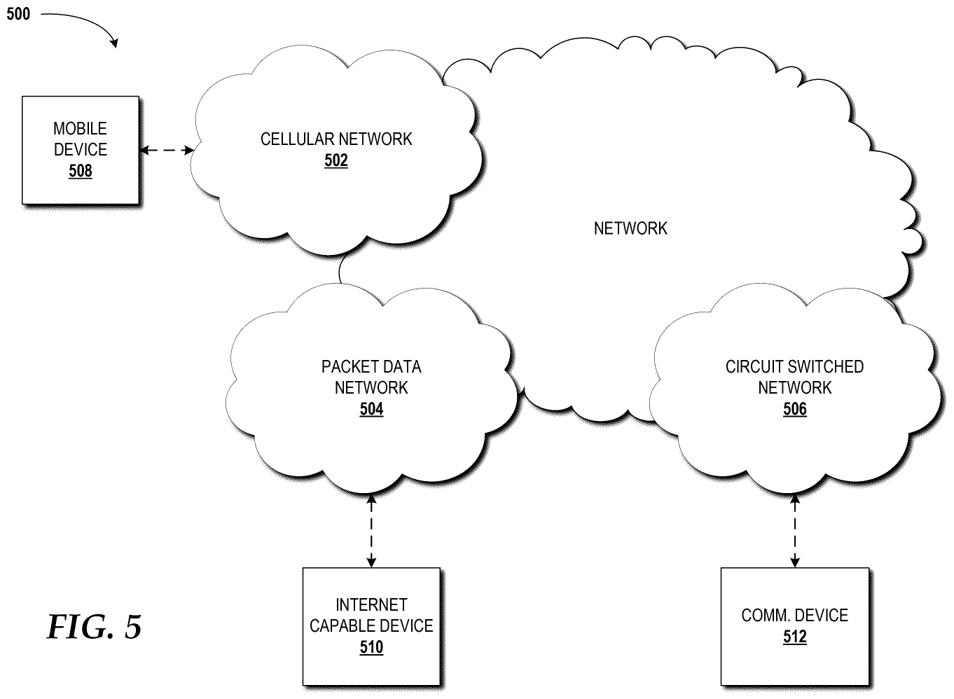

Turning now to FIG. 5, additional details of a network 500 are illustrated, according to an illustrative embodiment. The network 500 can include the RAN 106, the EPC network 114, the 5G core network 116, and/or the other network(s) 118. The illustrated network 500 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 502 also can include various interfaces between various components, as is generally understood. The cellular network 502 also includes radios and nodes for receiving and transmitting voice, data, and combinations thereof to and from radio transceivers, networks, the packet data network 504, and the circuit switched network 506.

A mobile communications device 508, such as, for example, the user device 108, the destination device 110, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 is also compatible with 4G mobile communications standards such as LTE, 5G mobile communications standards, 6G mobile communication standards, other mobile communications standards, and evolved and future mobile communications standards.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, the user device 108, the destination device 110, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 500 is used to refer broadly to any combination of the networks 502, 504, 506. It should be appreciated that substantially all of the functionality described with reference to the RAN 106, the EPC network 114, the 5G core network 116, and/or the other network(s) 118 can be performed by the cellular network 502, the packet data network 504, and/or the circuit switched network 506, alone or in combination with other networks, network elements, and the like.

FIG. 6 is a block diagram illustrating a computer system 600 configured to provide the functionality described herein for enabling management of calls and call transfers between linked devices to provide optimal connectivity for a call, in accordance with various embodiments of the concepts and technologies disclosed herein. The systems, devices, and other components disclosed herein, such as the server computer 120, components of the connected car 112, components of the EPC network 114, components of the 5G core network 116, components of the other network(s) 118, or some combination thereof can be implemented, at least in part, using an architecture that is the same as or similar to the architecture of the computer system 600. The computer system 600 includes a processing unit 602, a memory 604, one or more user interface devices 606, one or more input/output (“I/O”) devices 608, and one or more network devices 610, each of which is operatively connected to a system bus 612. The system bus 612 can enable bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the call transfer management service 122 and the call transfer management client 140. These and/or other programs can be embodied in computer-readable media containing instructions that, when executed by the processing unit 602, perform one or more of the methods 300 and 400 described in detail above with respect to FIGS. 3-4B and/or other functionality as illustrated and described herein. It can be appreciated that, at least by virtue of the instructions embodying the methods 300 and 400 and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the subscriber records 130A-130N and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network 618, such as the RAN 106, the EPC network 114, the 5G core network 116, and/or the other network(s) 118. Examples of the network devices 610 include, but are not limited to, a modem, a radio frequency (“RF”) or infrared (“IR”) transceiver, a telephonic interface, a bridge, a router, or a network card. The network 618 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 618 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Turning now to FIG. 7, an illustrative mobile device 700 and components thereof will be described. In some embodiments, the user device 108 and the destination device 110 described above with reference to FIG. 1 can be configured as and/or can have an architecture similar or identical to the mobile device 700 described herein in FIG. 7. It should be understood, however, that the user device 108 and/or the destination device 110 may or may not include the functionality described herein with reference to FIG. 7. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements such as, for example, device names, login information, passwords, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710, other computer-executable instructions stored in a memory 706, or the like. In some embodiments, the applications 710 also can include a UI application (not illustrated in FIG. 7).

The UI application can interface with the operating system 708 to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, creating device names, creating passwords, creating logins, selecting connections, requesting temporary connections, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include applications or program modules. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704.

It can be appreciated that, at least by virtue of storage of the instructions corresponding to the applications 710 and/or other instructions embodying other functionality illustrated and described herein in the memory 706, and/or by virtue of the instructions corresponding to the applications 710 and/or other instructions embodying other functionality illustrated and described herein being accessed and/or executed by the processor 704, the mobile device 700 is a special-purpose mobile device that can facilitate providing the functionality illustrated and described herein. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the RAN 106, the EPC network 114, the 5G core network 116, and/or the other network(s) 118 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, 5G, 6G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

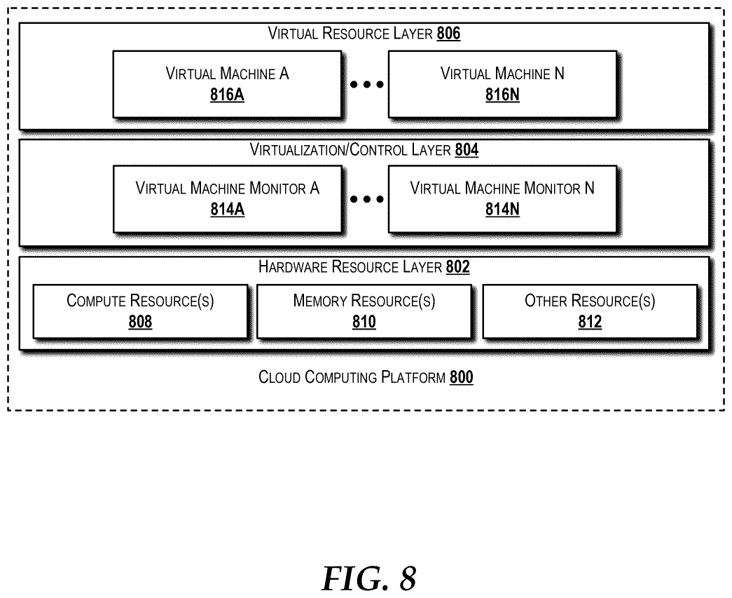

FIG. 8 illustrates an illustrative architecture for a cloud computing platform 800 that can be capable of executing the software components described herein for providing a call transfer management service that enables management of calls and call transfers between linked devices to provide optimal connectivity for a call, in accordance with various embodiments of the concepts and technologies disclosed herein. Thus, it can be appreciated that in some embodiments of the concepts and technologies disclosed herein, the cloud computing platform 800 illustrated in FIG. 8 can be used to provide the functionality described herein with respect to the call transfer management service 122.

The cloud computing platform 800 thus may be utilized to execute any aspects of the software components presented herein. Thus, according to various embodiments of the concepts and technologies disclosed herein, the call transfer management service 122 can be implemented, at least in part, on or by elements included in the cloud computing platform 800 illustrated and described herein. Those skilled in the art will appreciate that the illustrated cloud computing platform 800 is a simplification of but only one possible implementation of an illustrative cloud computing platform, and as such, the illustrated cloud computing platform 800 should not be construed as being limiting in any way.

In the illustrated embodiment, the cloud computing platform 800 can include a hardware resource layer 802, a virtualization/control layer 804, and a virtual resource layer 806. These layers and/or other layers can be configured to cooperate with each other and/or other elements of a cloud computing platform 800 to perform operations as will be described in detail herein. While connections are shown between some of the components illustrated in FIG. 8, it should be understood that some, none, or all of the components illustrated in FIG. 8 can be configured to interact with one another to carry out various functions described herein. In some embodiments, the components are arranged so as to communicate via one or more networks such as, for example, the RAN 106, the EPC network 114, the 5G core network 116, and/or the other network(s) 118 illustrated and described hereinabove (not shown in FIG. 8). Thus, it should be understood that FIG. 8 and the following description are intended to provide a general understanding of a suitable environment in which various aspects of embodiments can be implemented, and should not be construed as being limiting in any way.

The hardware resource layer 802 can provide hardware resources. In the illustrated embodiment, the hardware resources can include one or more compute resources 808, one or more memory resources 810, and one or more other resources 812. The compute resource(s) 808 can include one or more hardware components that can perform computations to process data, and/or to execute computer-executable instructions of one or more application programs, operating systems, services, and/or other software including, but not limited to, the call transfer management service 122 illustrated and described herein.

According to various embodiments, the compute resources 808 can include one or more central processing units (“CPUs”). The CPUs can be configured with one or more processing cores. In some embodiments, the compute resources 808 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 808 can include one or more discrete GPUs. In some other embodiments, the compute resources 808 can include one or more CPU and/or GPU components that can be configured in accordance with a co-processing CPU/GPU computing model. Thus, it can be appreciated that in some embodiments of the compute resources 808, a sequential part of an application can execute on a CPU and a computationally-intensive part of the application can be accelerated by the GPU. It should be understood that this example is illustrative, and therefore should not be construed as being limiting in any way.

In some embodiments, the compute resources 808 also can include one or more system on a chip (“SoC”) components. It should be understood that an SoC component can operate in association with one or more other components as illustrated and described herein, for example, one or more of the memory resources 810 and/or one or more of the other resources 812. In some embodiments in which an SoC component is included, the compute resources 808 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 808 can be or can include one or more hardware components arranged in accordance with an ARM architecture, available for license from ARM HOLDINGS of Cambridge, United Kingdom. Alternatively, the compute resources 808 can be or can include one or more hardware components arranged in accordance with an x86 architecture, such as an architecture available from INTEL CORPORATION of Mountain View, California, and others. Those skilled in the art will appreciate the implementation of the compute resources 808 can utilize various computation architectures and/or processing architectures. As such, the various example embodiments of the compute resources 808 as mentioned hereinabove should not be construed as being limiting in any way. Rather, implementations of embodiments of the concepts and technologies disclosed herein can be implemented using compute resources 808 having any of the particular computation architecture and/or combination of computation architectures mentioned herein as well as other architectures.

Although not separately illustrated in FIG. 8, it should be understood that the compute resources 808 illustrated and described herein can host and/or execute various services, applications, portals, and/or other functionality illustrated and described herein. Thus, the compute resources 808 can host and/or can execute the call transfer management service 122 or other applications or services illustrated and described herein.

The memory resource(s) 810 can include one or more hardware components that can perform or provide storage operations, including temporary and/or permanent storage operations. In some embodiments, the memory resource(s) 810 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 808, subject to the definition of “computer storage media” provided above (e.g., as excluding waves and signals per se and/or communication media as defined in this application).

Although not illustrated in FIG. 8, it should be understood that the memory resources 810 can host or store the various data illustrated and described herein including, but not limited to, the data store 128 and/or the subscriber records 130A-130N, if desired. It should be understood that this example is illustrative, and therefore should not be construed as being limiting in any way.

The other resource(s) 812 can include any other hardware resources that can be utilized by the compute resources(s) 808 and/or the memory resource(s) 810 to perform operations. The other resource(s) 812 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 802 can be virtualized by one or more virtual machine monitors (“VMMs”) 814A-814N (also known as “hypervisors;” hereinafter “VMMs 814”). The VMMs 814 can operate within the virtualization/control layer 804 to manage one or more virtual resources that can reside in the virtual resource layer 806. The VMMs 814 can be or can include software, firmware, and/or hardware that alone or in combination with other software, firmware, and/or hardware, can manage one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

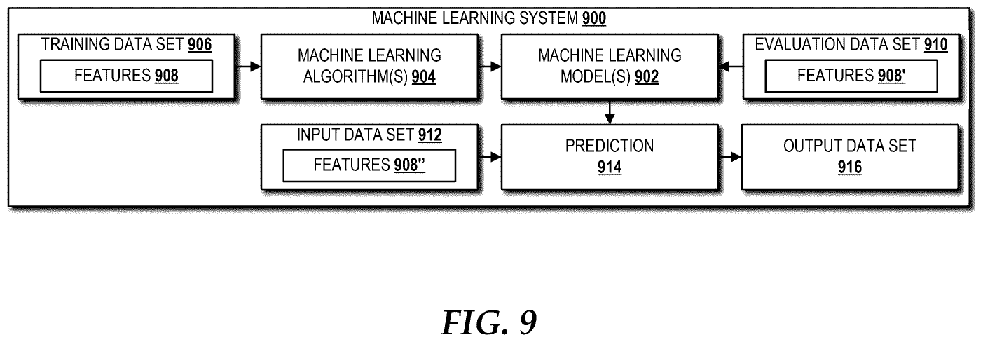

Turning now to FIG. 9, a machine learning system 900 capable of implementing aspects of the embodiments disclosed herein will be described. The machine learning system 900 can be used to train the call transfer management service 122. Accordingly, the server computer 120 can include the machine learning system 900 or can be in communication with the machine learning system 900.

The illustrated machine learning system 900 includes one or more machine learning models 902. The machine learning models 902 can include unsupervised, supervised, and/or semi-supervised learning models. The machine learning model(s) 902 can be created by the machine learning system 900 based upon one or more machine learning algorithms 904. The machine learning algorithm(s) 904 can be any existing, well-known algorithm, any proprietary algorithms, or any future machine learning algorithm. Some example machine learning algorithms 904 include, but are not limited to, time series autoregression, Seasonal and Trend Decomposition, Seasonal and Trend Decomposition using Loess (locally estimated scatterplot smoothing), Bayesian Estimator of Abrupt Change, Seasonality, Trend (BEAST), neural networks, gradient descent, linear regression, logistic regression, linear discriminant analysis, decision trees, Naive Bayes, K-nearest neighbor, learning vector quantization, support vector machines, principal component analysis, and the like. Those skilled in the art will appreciate the applicability of various machine learning algorithms 904 based upon the problem(s) to be solved by machine learning via the machine learning system 900.

The machine learning system 900 can control the creation of the machine learning models 902 via one or more training parameters (also referred to as “tuning parameters”). In some embodiments, the training parameters are selected variables or factors at the direction of an enterprise, for example. Alternatively, in some embodiments, the training parameters are automatically selected based upon data provided in one or more training data sets 906. The training parameters can include, for example, a learning rate where relevant such as when a classification algorithm is utilized, a model size, a number of training passes, data shuffling, regularization, and/or other training parameters known to those skilled in the art.

The learning rate is a training parameter defined by a constant value. The learning rate affects the speed at which the machine learning algorithm 904 converges to the optimal weights. The machine learning algorithm 904 can update the weights for every data example included in the training data sets 906. The size of an update is controlled by the learning rate. A learning rate that is too high might prevent the machine learning algorithm 904 from converging to the optimal weights. A learning rate that is too low might result in the machine learning algorithm 904 requiring multiple training passes to converge to the optimal weights.

The model size is regulated by the number of input features (“features”) 908 in the training data sets 906. The training data sets 906 and evaluation data sets 910 discussed further below may be selected based on an appropriate training/test split for training and evaluation, such as an 80/20 split.

The number of training passes indicates the number of training passes that the machine learning algorithm 904 makes over the training data sets 906 during the training process. The number of training passes can be adjusted based, for example, on the size of the training data sets 906, with larger training data sets being exposed to fewer training passes in consideration of time and/or resource utilization. The performance of the resultant machine learning model 902 can be increased by multiple training passes.

Data shuffling is a training parameter designed to prevent the machine learning algorithm 904 from reaching false optimal weights due to the order in which data contained in the training data sets 906 is processed. For example, data provided in rows and columns might be analyzed first row, second row, third row, etc., and thus an optimal weight might be obtained well before a full range of data has been considered. By data shuffling, the data contained in the training data sets 906 can be analyzed more thoroughly and mitigate bias in the resultant machine learning model 902.

Regularization is a training parameter that helps to prevent the machine learning model 902 from memorizing training data from the training data sets 906. In other words, the machine learning model 902 fits the training data sets 906, but the predictive performance of the machine learning model 902 is not acceptable. Regularization helps the machine learning system 900 avoid this overfitting/memorization problem by adjusting extreme weight values of the features 908. For example, a feature that has a small weight value relative to the weight values of the other features in the training data sets 906 can be adjusted to zero.

The machine learning system 900 can determine model accuracy, recall, precision, receiver operating characteristic (“ROC”) area under the curve (“AUC”), and/or other desired metrics after training by using the training data sets 906 with some of the features 908 and testing the machine learning model 902 with unseen evaluation data sets 910 containing the same features 908′ in the training data sets 906. This also prevents the machine learning model 902 from simply memorizing the data contained in the training data sets 906, which can overfit the data. The optimal or desired machine learning system 900 is reached when a target model accuracy or other desired metric threshold is met, which is understood through a model evaluation process in examining model performance on the evaluation data set 910. Once a machine learning model 902 has reached the desired metric threshold or optimal performance, the machine learning model 902 is considered ready for deployment.

After deployment, the machine learning model 902 can perform a prediction operation (“prediction”) 914 with an input data set 912 having the same features 908″ as the features 908 in the training data sets 906 and the features 908′ of the evaluation data sets 910. The results of the prediction 914 are included in an output data set 916 consisting of predicted data. The machine learning model 902 can perform other operations, such as regression, classification, and others. As such, the example illustrated in FIG. 9 should not be construed as being limiting in any way.

Based on the foregoing, it should be appreciated that systems and methods for enabling management of calls and call transfers between linked devices to provide optimal connectivity for a call have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions for a call transfer management service that, when executed by the processor, cause the processor to perform operations comprising
receiving a notification that a first device and a second device are within proximity of one another,
in response to the notification, determining that the first device and the second device are linked devices, and
in response to determining that the first device and the second device are linked devices and while the first device and the second device remain within proximity of one another, modifying call data associated with outgoing calls from the second device to assign a telephone number of the first device to the outgoing calls and modifying call data associated with incoming calls to the first device to reroute the incoming calls to the second device.

2. The system of claim 1, wherein the notification further comprises a request to transfer an in-progress call between the first device and a third device to the second device, and wherein the operations further comprise transferring the in-progress call to the second device such that the in-progress call is between the second device and the third device.

3. The system of claim 2, wherein transferring the in-progress call to the second device comprises:
instructing a base station serving the first device during the in-progress call to establish a connection with the second device; and
instructing the second device to activate a microphone associated with the second device to capture audio detected by the microphone and to send voice packets corresponding to the audio to the system.

4. The system of claim 3, wherein the operations further comprise:
analyzing audio quality of the voice packets received from the second device in comparison to audio quality of voice packets received from the first device during the in-progress call; and
in response to determining that the audio quality of the voice packets received from the second device exceeds the audio quality of the voice packets received from the first device,
instructing the base station to sever a connection used to service the first device for the in-progress call in favor of the connection between the base station and the second device,
sending the voice packets from the second device to the third device, and
forwarding voice packets from the third device to the second device via the base station to transfer the in-progress call to the second device.

5. The system of claim 2, wherein the operations further comprise:
receiving a notification that the first device and the second device are no longer within proximity of one other; and
transferring the in-progress call back to the first device such that the in-progress call is between the first device and the third device.

6. The system of claim 1, wherein the operations further comprise:
receiving a notification that the first device and the second device are no longer within proximity of one other; and
terminating assignment of the telephone number of the first device to the second device.

7. The system of claim 1, wherein the second device is a connected car.

8. A method comprising:
receiving, by a system comprising a processor executing a call transfer management service, a notification that a first device and a second device are within proximity of one another;
in response to the notification, determining, by the system, that the first device and the second device are linked devices; and
in response to determining that the first device and the second device are linked devices and while the first device and the second device remain within proximity of one another, modifying, by the system, call data associated with outgoing calls from the second device to assign a telephone number of the first device to the outgoing calls and modifying call data associated with incoming calls to the first device to reroute the incoming calls to the second device.

9. The method of claim 8, wherein the notification further comprises a request to transfer an in-progress call between the first device and a third device to the second device, and wherein the method further comprise transferring the in-progress call to the second device such that the in-progress call is between the second device and the third device.

10. The method of claim 9, wherein transferring the in-progress call to the second device comprises:
instructing a base station serving the first device during the in-progress call to establish a connection with the second device; and
instructing the second device to activate a microphone associated with the second device to capture audio detected by the microphone and to send voice packets corresponding to the audio to the system.

11. The method of claim 10, further comprising:
analyzing audio quality of the voice packets received from the second device in comparison to audio quality of voice packets received from the first device during the in-progress call; and
in response to determining that the audio quality of the voice packets received from the second device exceeds the audio quality of the voice packets received from the first device,
instructing the base station to sever a connection used to service the first device for the in-progress call in favor of the connection between the base station and the second device,
sending the voice packets from the second device to the third device, and
forwarding voice packets from the third device to the second device via the base station to transfer the in-progress call to the second device.

12. The method of claim 9, further comprising:
receiving a notification that the first device and the second device are no longer within proximity of one other; and
transferring the in-progress call back to the first device such that the in-progress call is between the first device and the third device.

13. The method of claim 8, further comprising:
receiving a notification that the first device and the second device are no longer within proximity of one other; and
terminating assignment of the telephone number of the first device to the second device.

14. The method of claim 8, wherein the second device is a connected car.

15. A computer storage medium having computer-executable instructions for a call transfer management service stored thereon that, when executed by a processor of a system, cause the processor to perform operations comprising:
receiving a notification that a first device and a second device are within proximity of one another;
in response to the notification, determining that the first device and the second device are linked devices; and
in response to determining that the first device and the second device are linked devices and while the first device and the second device remain within proximity of one another, modifying call data associated with outgoing calls from the second device to assign a telephone number of the first device to the outgoing calls and modifying call data associated with incoming calls to the first device to reroute the incoming calls to the second device.

16. The computer storage medium of claim 15, wherein the notification further comprises a request to transfer an in-progress call between the first device and a third device to the second device, and wherein the operations further comprise transferring the in-progress call to the second device such that the in-progress call is between the second device and the third device.

17. The computer storage medium of claim 16, wherein transferring the in-progress call to the second device comprises:
instructing a base station serving the first device during the in-progress call to establish a connection with the second device; and
instructing the second device to activate a microphone associated with the second device to capture audio detected by the microphone and to send voice packets corresponding to the audio to the system.

18. The computer storage medium of claim 17, further comprising:
analyzing audio quality of the voice packets received from the second device in comparison to audio quality of voice packets received from the first device during the in-progress call; and
in response to determining that the audio quality of the voice packets received from the second device exceeds the audio quality of the voice packets received from the first device,
instructing the base station to sever a connection used to service the first device for the in-progress call in favor of the connection between the base station and the second device,
sending the voice packets from the second device to the third device, and
forwarding voice packets from the third device to the second device via the base station to transfer the in-progress call to the second device.

19. The computer storage medium of claim 16, further comprising:
receiving a notification that the first device and the second device are no longer within proximity of one other; and
transferring the in-progress call back to the first device such that the in-progress call is between the first device and the third device.

20. The computer storage medium of claim 15, wherein the second device is a connected car.
